(19) United States
(12) Patent Application Publication
(10) Pub. No.: US 2010/0208596 A1
(43) Pub. Date: Aug. 19, 2010

(54) APPARATUS AND METHOD FOR MANAGING PATH BETWEEN NODES IN MOBILE COMMUNICATION SYSTEM

(75) Inventor: Sun-Il JIN, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/706,224

(22) Filed: Feb. 16, 2010

(30) Foreign Application Priority Data
Feb. 16, 2009 (KR) 10-2009-0012542

(51) Int. Cl. H04L 12/26; H04W 4/00

(52) U.S. Cl. 370/242; 370/328

(57) ABSTRACT

A method and apparatus for managing a path between nodes in a mobile communication system are provided. The method of a node for managing the path between the nodes includes transmitting/receiving a call setup message including information about a higher node for a call to/from a different node, storing the information about the higher node for the call and information of the different node by associating the two pieces of information with the call, sensing an abnormal operation of a path to a specific node, searching for a call stored in association with the specific node whose abnormal operation is sensed, and deleting information related to the call.

### PRIORITY

This application claims the benefit under 35 U.S.C. §119(a) of a Korean patent application filed in the Korean Intellectual Property Office on Feb. 16, 2009 and assigned Serial No. 10-2009-0012542, the entire disclosure of which is hereby incorporated by reference.

### BACKGROUND OF THE INVENTION

1. Field of the Invention

Aspects of the present invention relate to an apparatus and method for managing a path between nodes in a mobile communication system. More particularly, aspects of the present invention relate to an apparatus and method for managing a path for a specific node when the specific node operates abnormally in an Evolved Packet Core (EPC) system.

2. Description of the Related Art

Subsequent to standardization for a system and terminal of wideband code division multiple access, standardization works for next generation mobile communication are ongoing in the 3rd Generation Partnership Project (3GPP). In addition, a structure for an Enhanced Packet Core (EPC) and a related protocol are being standardized.

FIG. 1 illustrates a structure of a conventional EPC system 100.

Referring to FIG. 1, in order for a plurality of Mobility Management Entities (MMEs) 110 to provide a user plane bearer in the EPC system 100, a bearer is created and updated by selecting one Serving-GateWay (S-GW) 120 from a plurality of S-GWs. The S-GW 120 may act as an anchor point for performing mobility management in a 3GPP network, and a Packet Data Network (PDN) GateWay (P-GW) 130 may act as an anchor point for performing mobility management in the 3GPP network and a non-3GPP network.

In the EPC system 100, an echo request and echo response message having a format as shown in Table 1 below is used to manage a path to each node by determining whether each node operates normally. Table 1 below illustrates the format of the echo request and echo response message.

TABLE 1

| Information elements | P | Condition/Comment | CR | IE Type |
|---|---|---|---|---|
| Recovery | M | NONE | 1 | Recovery |
| Private | O | NONE | 0 | Private Extension |

Herein, “Recovery” denotes a system reset count of a specific node, “P” denotes a Post condition, “M” denotes a Mandatory, “O” denotes an Optional, and ‘CR’ denotes a Change Request.

As shown in Table 1 above, each node of the EPC system uses the echo request and echo response message including the system reset count to perform path management by recognizing whether a problem occurs in a path to a peer node.

However, since the path management using the echo request and echo response message is a path management method performed between one node and another node, it is not suitable as a path management method of a system including an intermediary node. For example, if the MME, the S-GW, and the P-GW are used in the EPC system, when the MME operates abnormally, the S-GW may determine that the MME operates abnormally by transmitting/receiving the echo request and echo response message to/from the MME and then delete call data associated with the MME. In this case, the P-GW cannot know that the MME operates abnormally. Therefore, in order for the P-GW to release the call associated with the MME, the S-GW has to transmit a call release message to the P-GW. The number of call release messages generated in this case is equal to the number of calls which are set up in association with the MME. Each of these generated messages is transmitted to the P-GW. For example, if one million calls are set up in association with the P-GW and the MME, the S-GW instantaneously generates one million call release messages and transmits the generated messages to the P-GW. This may cause a system overload not only for the S-GW which generates and transmits the call release message but also for the P-FW which receives the call release message. Further, there is a problem in that a specific path is congested.

As described above, the conventional path management method has a disadvantage in that a system overload is generated or a congestion situation occurs. Accordingly, there is a need to provide a more effective path management method.

### SUMMARY OF THE INVENTION

Aspects of the present invention address at least the above-mentioned problems and/or disadvantages and to provide at least the advantages described below. Accordingly, an aspect of the present invention is to provide an apparatus and method for managing a path between nodes in a mobile communication system.

Another aspect of the present invention is to provide an apparatus and method for managing a call of a specific node when the specific node operates abnormally in an Evolved Packet Core (EPC) system.

Another aspect of the present invention is to provide an apparatus and for releasing a call for a specific node when a path to the specific node is abnormal by using a create session message and a modify bearer message including an address of the node in an EPC system.

Another aspect of the present invention is to provide an apparatus and method in which an intermediary node between nodes in an EPC system announces to another node that a path to a specific node is in an abnormal status.

Another aspect of the present invention is to provide an apparatus and method for deleting call data related to a specific node in an EPC system by receiving a message for announcing that a path to a specific node is in an abnormal status.

In accordance with an aspect of the present invention, a method of a node for managing a path between nodes in a mobile communication system is provided. The method includes transmitting a call setup message including information about a higher node for a call to a different node and/or receiving the call setup message from the different node, storing the information about the higher node for the call and information about the different node by associating the two pieces of information with the call, sensing an abnormal operation of a path to a specific node, searching for a call stored in association with the specific node whose abnormal operation is sensed, and deleting information related to the call.

In accordance with another aspect of the present invention, an apparatus of an intermediary node for managing a path between nodes in a mobile communication system is provided. The apparatus includes a transceiver for transmitting a call setup message comprising information of a higher node for a call to a different node and/or receiving the call setup message from the different node, a storage module for storing the information about the higher node for the call and information about the different node by associating the two pieces of information with the call, a sensor for sensing an abnormal operation of a path to a specific node, and a call session manager for searching for a call stored in association with the specific node whose abnormal operation is sensed, and for deleting information related to the call.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a structure of a conventional Evolved Packet Core (EPC) system;

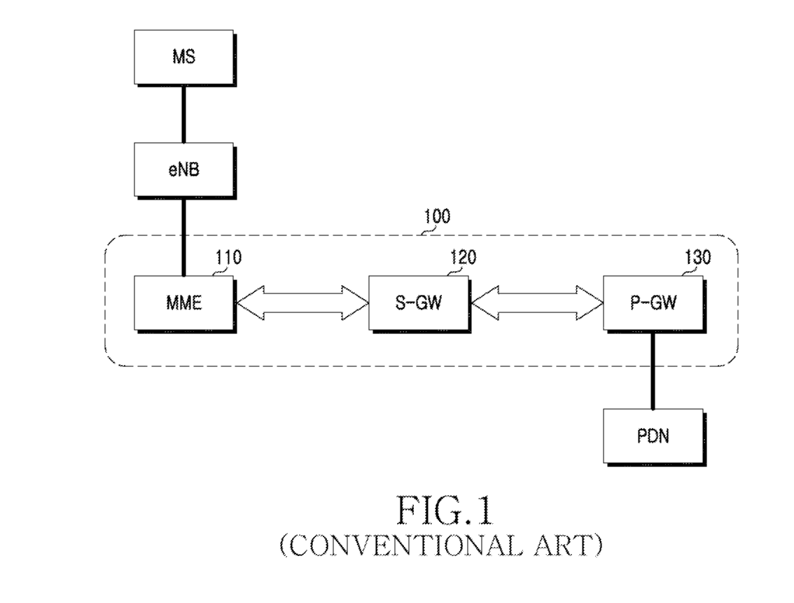

FIG. 2 is a block diagram illustrating each node of an EPC system according to an exemplary embodiment of the present invention;

FIG. 3 is a flowchart illustrating a call setup process for performing path management between nodes in an EPC system according to an exemplary embodiment of the present invention;

FIG. 4 is a flowchart illustrating a call setup process of a Serving-GateWay (S-GW) in an EPC system according to an exemplary embodiment of the present invention;

FIG. 5 is a flowchart illustrating a call setup process of a Packet Data Network (PDN) GateWay (P-GW) in an EPC system according to an exemplary embodiment of the present invention;

FIG. 6 is a flowchart illustrating a path management process at the occurrence of a path failure with respect to an eNodeB (eNB) in an EPC system according to an exemplary embodiment of the present invention;

FIG. 7 is a flowchart illustrating a path management process at the occurrence of a path failure with respect to a Mobility Management Entity (MME) in an EPC system according to an exemplary embodiment of the present invention;

FIG. 8 is a flowchart illustrating a path management process at the occurrence of a path failure with respect to a P-GW in an EPC system according to an exemplary embodiment of the present invention;

FIG. 9 is a flowchart illustrating a path management process at the occurrence of a path failure with respect to an S-GW in an EPC system according to an exemplary embodiment of the present invention;

FIG. 10 is a flowchart illustrating a process of performing path management by an S-GW by recognizing occurrence of a path failure with respect to a peer node in an EPC system according to an exemplary embodiment of the present invention;

FIG. 11 is a flowchart illustrating a process of performing path management by an MME or a P-GW by receiving information indicating occurrence of a path failure from an S-GW according to an exemplary embodiment of the present invention; and

FIG. 12 is a flowchart illustrating a process of performing path management by an MME or a P-GW by recognizing occurrence of a path failure from an S-GW according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for the purpose of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, an apparatus and for performing path management between nodes in an Evolved Packet Core (EPC) system by using a create session message and a modify bearer message including a node address and a message for announcing occurrence of a path failure for a specific node will be described. To perform path management between nodes through S5/S8/S11/S4 interfaces proposed in the EPC system, an exemplary embodiment of the present invention adds address information of a higher node for a specific call to a call setup message as shown in Table 2 and Table 3 below.

Table 2 below illustrates information added to a create session request message.

TABLE 2

| Information Elements | P | Condition/Comment | CR | IE Type |
|---|---|---|---|---|
| MME S11 Address for | C | Address information of | 1 | IP Address |
| Path Fail Check | | SGSN or MME for | | |
| | | signaling | | |

As shown in Table 2, “MME S11 Address for Path Fail Check” is an information element indicating address information of a higher node for signaling of a specific call, that is, an address of a Mobility Management Entity (MME) or a Servicing GPRS Support Node (SGSN). GPRS refers to the General Packet Radio Service. Herein, “C” denotes a Conditional.

Table 3 below illustrates information added to a modify bearer request message.

TABLE 3

| Information Elements | P | Condition/Comment | CR | IE Type |
|---|---|---|---|---|
| eNodeB S1-U Address | M | Address information | 1 | IP Address |
| | | of RNC or eNodeB for | | |
| | | Data Traffic (S1-2,S12) | | |

As shown in Table 3 above, “eNodeB S1-U Address” is an information element indicating address information of a higher node for data traffic of a specific call, that is, an address of an eNodeB (eNB) or a Radio Network Controller (RNC).

In an exemplary embodiment of the present invention, address information of a higher node of a specific call is transmitted by inserting the address information to a create session request message and a modify bearer request message related to call setup as shown in Table 2 and Table 3. Thus, when a node which has received the create session request message and the modify bearer request message stores the address information of the higher node in association with the call, and a path failure occurs with respect to the higher node, data of the call stored in association with the higher node is deleted.

In addition, an exemplary embodiment of the present invention additionally defines a message announcing the path failure with respect to the specific node to another node in order to perform path management between nodes through the S5/S8/S11/S4 interfaces proposed in the EPC system. That is, an exemplary embodiment of the present invention additionally defines a path failure notification message announcing the path failure with respect to the specific node and a path failure acknowledgement message used as an acknowledgement for the path failure notification message.

Table 4 below illustrates a message header additionally defined according to an exemplary embodiment of the present invention.

TABLE 4

| | | | | | | | | |
|---|---|---|---|---|---|---|---|---|
| Octets | 8 | 7 | 6 | 5 | 4 | 3 | 2 | 1 |

| | | | | | | |
|---|---|---|---|---|---|---|
| 1 | 2 | FFS | T = 0 | E = 0 | S = 1 | FFS |

| | |
|---|---|
| 2 | Message Type - 4 or 5 |
| 3 | Message Length (1^{st} Octet) |
| 4 | Message Length(2^{nd} Octet) |
| 5 | Sequence Number(1^{st} Octet) |
| 6 | Sequence Number(2^{nd} Octet) |
| 7 | Spare |
| 8 | Spare |

As shown in Table 4 above, in the messages additionally defined in the exemplary embodiment of the present invention, T is set to 0 to indicate that a Tunnel Endpoint ID (TEID) does not exist as in a typical path management message, and a message type is set to a number which is in a reserved state. Although the message type of the path failure notification message is set to 4 which is currently reserved and the message type of the path failure acknowledgement message is set to 5 which is also currently reserved, this is for exemplary purposes only, and thus the message type may be set to another number as long as the number is in the reserved state.

Table 5 below illustrates a payload configuration of the path failure notification message additionally defined according to an exemplary embodiment of the present invention.

TABLE 5

| Information | | | | |
|---|---|---|---|---|
| Elements | P | Condition/Comment | CR | IE Type |
| Recovery | M | NONE | 1 | Recovery |
| Node Type | M | Type of Node(eNodeB, MME, | 1 | Node Type |
| | | S-GW, P-GW, RNC and SGSN) | | |
| | | experiencing a path failure | | |
| Failed Node | M | IP address information of Node | 1 | IP Address |
| Address | | experiencing a path failure | | |
| Private | O | NONE | 0 | Private |
| Extension | | | | Extension |

As shown in Table 5 above, “Recovery” denotes a system reset count of a specific node, “Node Type” denotes a type of a node experiencing a path failure, “Failed Node Address” denotes Internet Protocol (IP) address information of the node experiencing the path failure, and “Private Extension” denotes information that can be additionally added. As shown in Table 5 above, the path failure notification message additionally added in the exemplary embodiment of the present invention includes a type and address of the node experiencing the path failure so that the node receiving the path failure notification message can recognize that the path failure occurs with respect to the node indicated in the message.

“Node Type” is configured as shown in Table 6 below. A type of each node is defined as shown in Table 7 below.

TABLE 6

| | | | | | | | | |
|---|---|---|---|---|---|---|---|---|
| Octets | 8 | 7 | 6 | 5 | 4 | 3 | 2 | 1 |

| | |
|---|---|
| 1 | Type = 138 (decimal) |
| 2-3 | Length = 1(decimal) |
| 4 | NODE Type |

TABLE 7

| NODE Types | Values (decimal) |
|---|---|
| <reserved> | 0 |
| MME | 1 |
| S-GW | 2 |
| P-GW | 3 |
| SGSN | 4 |
| GGSN | 5 |
| eNodeB | 6 |
| RNC | 7 |
| <spare> | 8-255 |

In Table 7 above, a type value of each node is defined for exemplary purposes only, and thus the type value of each node may be defined to another value. Additional nodes may also be defined in Table 7, as needed.

Table 8 shows a payload configuration of the path failure acknowledgment message additionally defined according to an exemplary embodiment of the present invention.

TABLE 8

| Information elements | P | Condition/Comment | CR | IE Type |
|---|---|---|---|---|
| Recovery | M | NONE | 1 | Recovery |
| Private Extension | O | NONE | 0 | Private Extension |

As shown in Table 8 above, “Recovery” denotes a system reset count of a specific node, and “Private Extension” denotes information that can be additionally added.

A structure of each node and a process of performing path management on the basis of the aforementioned description will be explained according to exemplary embodiments of the present invention.

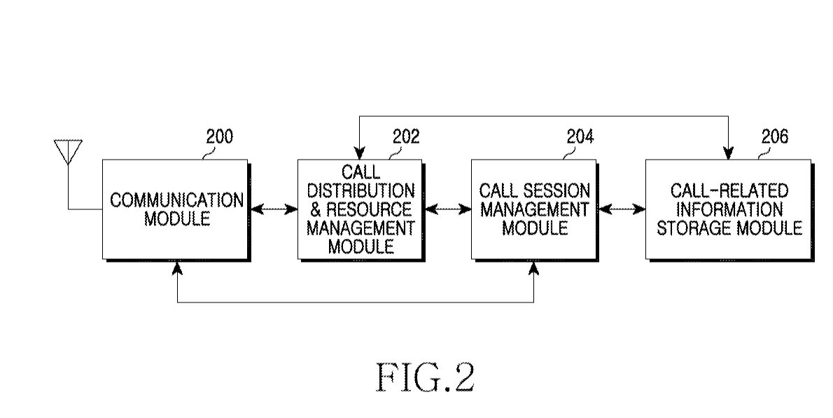

FIG. 2 is a block diagram illustrating each node of an EPC system according to an exemplary embodiment of the present invention.

Referring to FIG. 2, each node includes a communication module 200, a call distribution & resource management module 202, a call session management module 204, and a call-related information storage module 206.

The communication module 200 processes a message transmitted and received to and from a peer node.

The call distribution & resource management module 202 properly distributes a call to each node and manages a resource. The call distribution & resource management module 202 adds address information of a higher node for a specific call to a create session request message or a modify bearer request message for call setup. The call distribution & resource management module 202 may also evaluate the address information of the higher node for the specific call from the create session request message or a modify bearer response message. In addition, the call distribution & resource management module 202 provides information related to the specific call and the address information of the evaluated higher node to the call-related information storage module 206.

Further, the call distribution & resource management module 202 determines whether a path to a peer node is normal according to an echo response message, which is a response for an echo request message for the peer node. In this case, the call distribution & resource management module 202 may determine whether the path to the peer node is normal according to whether the echo response message is received within a pre-set time or whether a reset count included in the received echo response message is changed. If the echo response message is not received within the pre-set time or the reset count included in the received echo response message is changed, the call distribution & resource management module 202 determines that the path to the peer node is abnormal and announces the occurrence of a path failure with respect to the peer node to the call session management module 204.

When a signal announcing the occurrence of a path failure with respect to a specific node is input from the call distribution & resource management module 202, the call session management module 204 evaluates a call for the specific node and information of other nodes associated with the call for the specific node using the call-related information storage module 206. The call session management module 204 thereafter controls and processes a function for transmitting a path failure notification message including a type and address information of the specific node to the evaluated other nodes. Upon receiving a path failure acknowledgment message from the other nodes, the call session management module 204 controls and processes a function for deleting information related to the call for the specific node among information stored in the call-related information storage module 206. Upon receiving a path failure notification message from the other nodes, the call session management module 204 analyzes the received path failure notification message to evaluate a type and address of a node experiencing the path failure, and controls and processes a function for deleting call-related information corresponding to the evaluated node type and address among the call-related information stored in the call-related information storage module 206.

The call-related information storage module 206 stores the call-related information. The call-related information storage module 206 stores the call-related information by associating the call-related information with information of a node for a specific call.

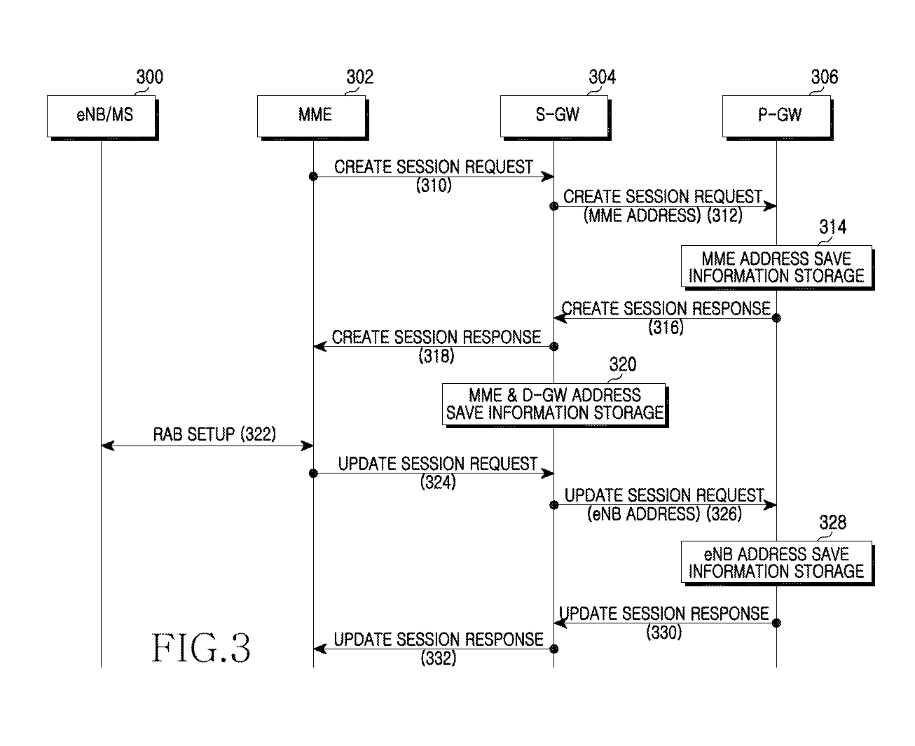

FIG. 3 is a flowchart illustrating a call setup process for performing path management between nodes in an EPC system according to an exemplary embodiment of the present invention.

Referring to FIG. 3, for call setup requested from an eNB/MS 300, an MME 302 transmits a create session request message to an S-GW 304 in step 310. Then, in step 312, the S-GW 304 adds address information of the MME 302 to the create session request message as shown in Table 2 above, and transmits the resultant message to a P-GW 306.

In step 314, the P-GW 306 stores the MME 302's address information included in the create session request message by associating the address information with a call created by the create session request message. In step 316, the P-GW 306 transmits a create session response message to the S-GW 304. In this case, the P-GW 306 may perform steps 314 and 316 in a parallel manner, or may first perform step 316, followed by step 314.

In step 318, the S-GW 304 transmits the create session response message to the MME 302. In step 320, the S-GW 304 stores address information of the MME 302 and the P-GW 306 by associating the address information with information on a call created between the MME 302 and the P-GW 306. The S-GW 304 may perform steps 318 and 320 in a parallel manner, or may first perform step 320, followed by step 318.

In step 322, the MME 302 sets up a Radio Access Bearer (RAB) with respect to the eNB/MS 300. In step 324, the MME 302 transmits a modify bearer request message to the S-GW 304. In step 326, the S-GW 304 transmits the modify bearer request message to the P-GW 306 by adding address information of the eNB 300, which is a higher node of a specific call, to the modify bearer request message as shown in Table 3 above.

In step 328, the P-GW 306 stores the eNB 300's address information included in the modify bearer request message by associating the address information with a call updated by the modify bearer request message. In step 330, the P-GW 306 transmits a modify bearer response message to the S-GW 304. The P-GW 306 may perform steps 328 and 330 in a parallel manner, or may first perform step 330, followed by step 328.

In step 332, the S-GW 304 transmits the create session response message to the MME 302. In this case, the S-GW 304 may store the address of the eNB 300 by associating it with the information stored in step 320.

Although the address information of a higher node for a specific call is described above as included in the create session request message and the modify bearer request message transmitted by the S-GW 304 to the P-GW 306, the address information of the higher node of the specific call may also be included in the create session request message and the modify bearer request message transmitted by the MME 302 to the S-GW 304.

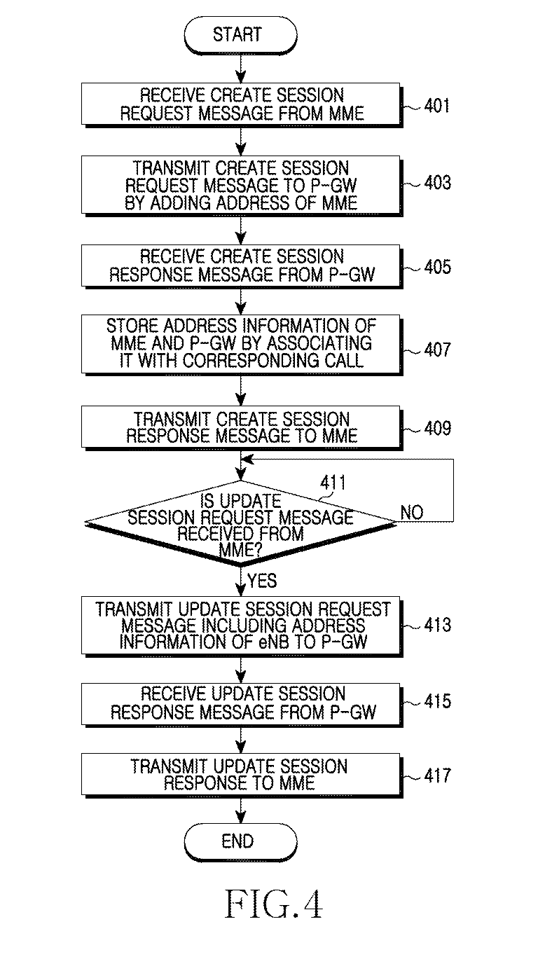

FIG. 4 is a flowchart illustrating a call setup process of an S-GW in an EPC system according to an exemplary embodiment of the present invention.

Referring to FIG. 4, the S-GW receives a create session request message for call setup from an MME in step 401. In step 403, the S-GW adds address information of the MME to the create session request message as shown in Table 2 above, and transmits the resultant message to a P-GW. In step 405, the S-GW receives a create session response message from the P-GW. In step 407, the S-GW stores address information of the MME and the P-GW by associating the additional information with information on a call to be created between the MME and the P-GW. In step 409, the S-GW transmits the create session response message to the MME.

In step 411, the S-GW examines whether a modify bearer request message is received from the MME. If the modify bearer request is received, then in step 413, the S-GW transmits the modify bearer request message to the P-GW by adding address information of an eNB, which is a higher node of a specific call, to the modify bearer request message, as shown in Table 3 above. In step 415, the S-GW receives a modify bearer response message from the P-GW. In step 417, the S-GW transmits the modify bearer response message to the MME. In this case, the S-GW may store the address information of the eNB by associating the address information with the information stored in step 407.

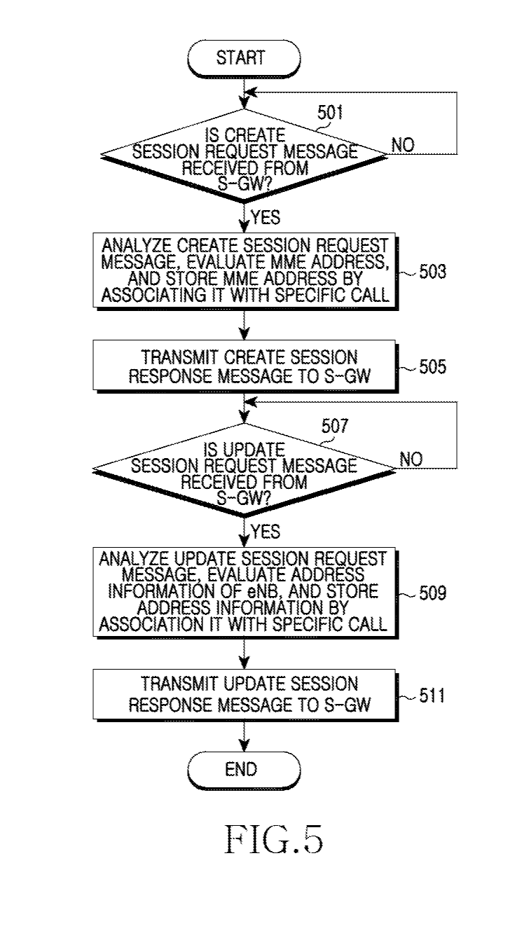

FIG. 5 is a flowchart illustrating a call setup process of a P-GW in an EPC system according to an exemplary embodiment of the present invention.

Referring to FIG. 5, if the P-GW receives a create session request message from an S-GW in step 501, then in step 503, the P-GW analyzes the create session request message to evaluate address information of an MME, and stores the evaluated address information by associating the address information with a specific call corresponding to the create session request message. When the address information of the MME is stored in association with the specific call, the P-GW also stores information of the S-GW by associating the information with the specific call. In step 505, the P-GW transmits a create session response message to the S-GW.

In step 507, the P-GW examines whether a modify bearer request message is received from the S-GW. If the modify bearer request message is received, then in step 509, the P-GW analyzes the modify bearer request message to evaluate address information of an eNB, and stores the evaluated address information of the eNB by associating the address information with a call updated by the modify bearer request message. In step 511, the P-GW transmits a modify bearer response message to the S-GW.

As described with reference to FIG. 3 to FIG. 5, the address information of the higher node for the specific call is added to the create session request message and the modify bearer message transmitted by the S-GW to the P-GW so that the P-GW can store and manage the address information of the higher node for each set-up call.

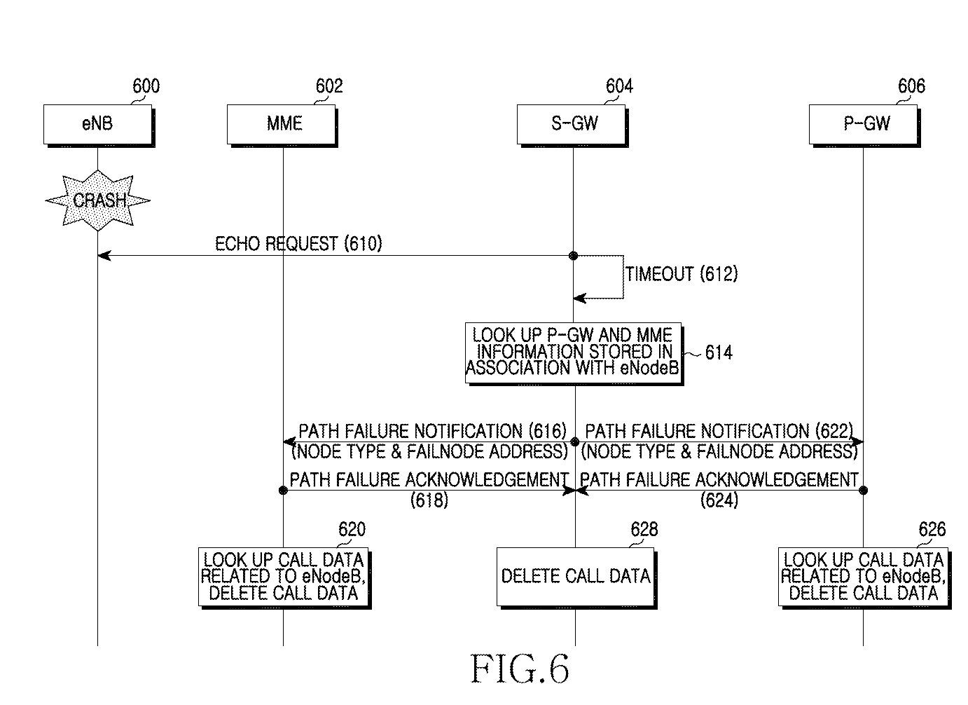

FIG. 6 is a flowchart illustrating a path management process at the occurrence of a path failure with respect to an eNB in an EPC system according to an exemplary embodiment of the present invention.

Referring to FIG. 6, an S-GW 604 transmits an echo request message to an eNB 600 in step 610, and waits for an echo response message received from the eNB 600 for a pre-set time in step 612.

If an abnormal situation occurs in the eNB 600 or on a path to the eNB 600 and thus the S-GW 604 fails to receive the echo response message within the pre-set time, the S-GW 604 recognizes occurrence of a path failure with respect to the eNB 600. Then, in step 614, the S-GW 604 searches for information of an MME 602 and a P-GW 606. The information is pre-stored in association with a call corresponding to the eNB 600. In steps 616 and 622, the S-GW 604 transmits a path failure notification message to the MME 602 and the P-GW 606. The path failure notification message includes a node type and address information of the eNB 600, that is, a node in which a path failure occurs, as shown in Table 5 above.

In steps 618 and 624, the MME 602 and the P-GW 606 respectively transmit a path failure acknowledgment message to the S-GW 604 as shown in Table 8 above. In steps 620 and 626, the MME 602 and the P-GW 606 respectively determine that the node in which the path failure occurs is the eNB 600 by analyzing the path failure notification message, and deletes call-related information stored in association with the address information of the eNB 600. In this case, the MME 602 may delete the call-related information by pre-recognizing the path failure with respect to the eNB 600 through an S1 interface. Meanwhile, if the path failure acknowledgment message is received from the MME 602 and the P-GW 606 respectively in steps 618 and 624, then in step 628, the S-GW 604 deletes the call-related information stored in association with the address information of the eNB 600.

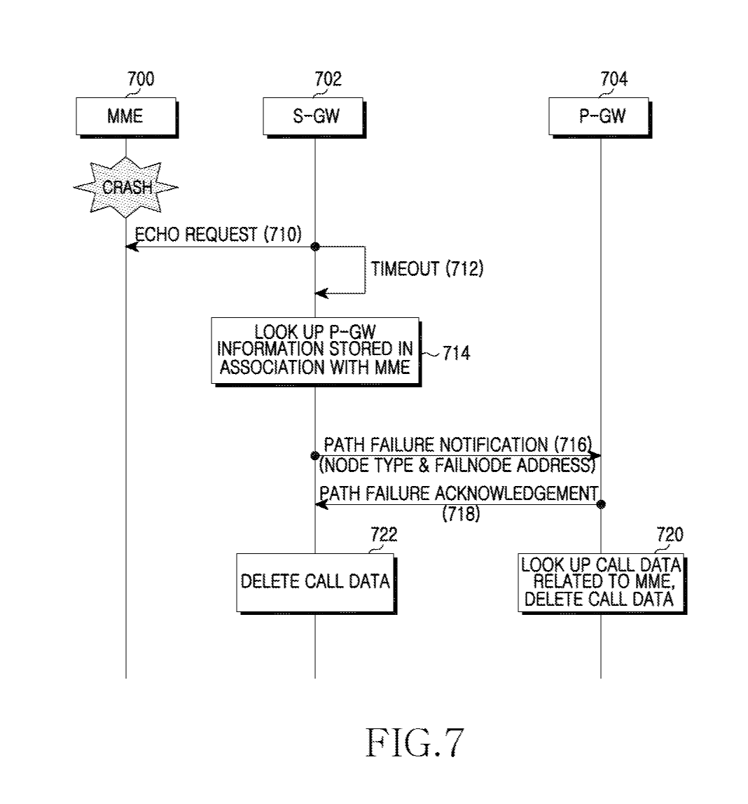

FIG. 7 is a flowchart illustrating a path management process at the occurrence of a path failure with respect to an MME in an EPC system according to an exemplary embodiment of the present invention.

Referring to FIG. 7, an S-GW 702 transmits an echo request message to an MME 700 in step 710, and waits for an echo response message received from the MME 700 for a pre-set time in step 712.

If an abnormal situation occurs in the MME 700 or on a path to the MME 700 and thus the S-GW 702 fails to receive the echo response message within the pre-set time, or if the echo response message is received within the pre-set time but reset count information included in the received echo response message is changed, the S-GW 702 recognizes occurrence of a path failure with respect to the MME 700. Accordingly, the S-GW 702 searches for information of a P-GW 704 in step 714. The information is pre-stored in association with the MME 700. In step 716, the S-GW 702 transmits a path failure notification message to the P-GW 704. The path failure notification message includes a node type and address information of the MME 700, that is, a node in which a path failure occurs, as shown in Table 5 above.

In step 718, the P-GW 704 transmits a path failure acknowledgment message to the S-GW 702 as shown in Table 8 above. In step 720, the P-GW 704 determines that a node in which the path failure occurs is the MME 700 by analyzing the path failure notification message, and deletes call-related information stored in association with the address information of the MME 700. When the path failure acknowledgment message is received from the P-GW 704, the S-GW 702 deletes the call-related information stored in association with the address information of the MME 700 in step 722.

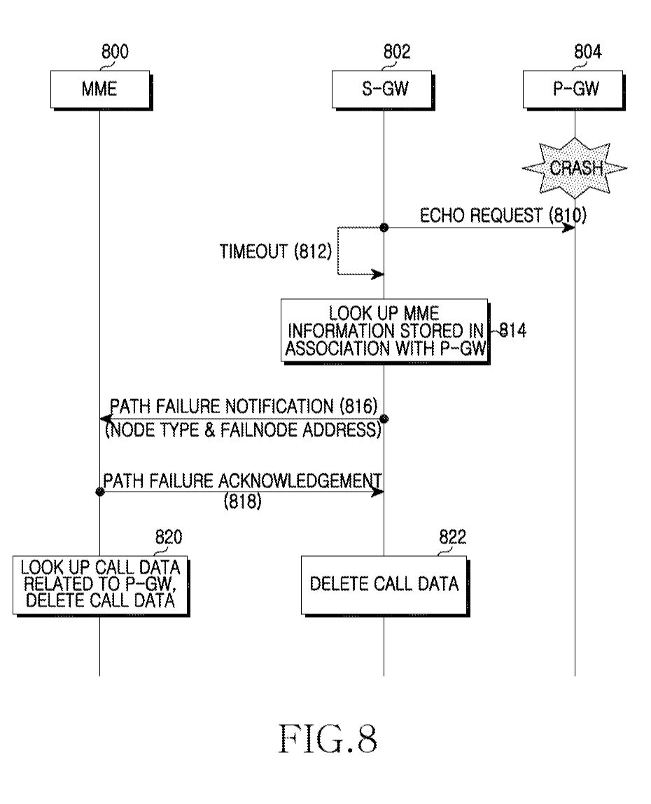

FIG. 8 is a flowchart illustrating a path management process at the occurrence of a path failure with respect to a P-GW in an EPC system according to an exemplary embodiment of the present invention.

Referring to FIG. 8, an S-GW 802 transmits an echo request message to a P-GW 804 in step 810, and waits a pre-set time for an echo response message received from the P-GW 804 in step 812.

If an abnormal situation occurs in the P-GW 804 or on a path to the P-GW 804 and thus the S-GW 802 fails to receive the echo response message with the pre-set time, or if the echo response message is received within the pre-set time but reset count information included in the received echo response message is changed, the S-GW 802 recognizes occurrence of a path failure with respect to the P-GW 804. Accordingly, the S-GW 802 searches for information of an MME 800 in step 814. The information is pre-stored in association with the P-GW 804. In step 816, the S-GW 802 transmits a path failure notification message to the MME 800. The path failure notification message includes a node type and address information of the P-GW 804, that is, a node in which a path failure occurs, as shown in Table 5 above.

In step 818, the MME 800 transmits a path failure acknowledgment message to the S-GW 802 as shown in Table 8 above. In step 820, the MME 800 determines that a node in which the path failure occurs is the P-GW 804 by analyzing the path failure notification message, and deletes call-related information stored in association with the address information of the P-GW 804. In this case, the MME 800 may transmit a cell delete request message to a specific eNB sequentially with a time interval in the process of deleting the call-related information, so that the eNB can be avoided from overhead caused by instantaneous call release. When the path failure acknowledgment message is received from the MME 800 in step 818, the S-GW 802 deletes the call-related information stored in association with the address information of the P-GW 804 in step 822.

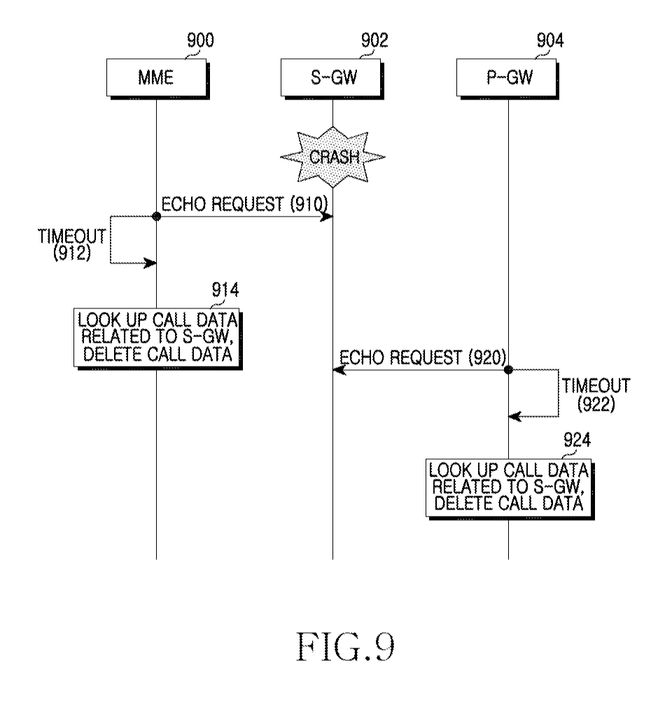

FIG. 9 is a flowchart illustrating a path management process at the occurrence of a path failure with respect to an S-GW in an EPC system according to an exemplary embodiment of the present invention.

Referring to FIG. 9, an MME 900 transmits an echo request message to an S-GW 902 in step 910, and waits for an echo response message received from the S-GW 902 for a pre-set time in step 912.

If an abnormal situation occurs in the S-GW 902 or on a path to the S-GW 902 and thus the MME 900 fails to receive the echo response message within the pre-set time, or if the echo response message is received within the pre-set time but reset count information included in the received echo response message is changed, the MME 900 recognizes occurrence of a path failure with respect to the S-GW 902. Accordingly, in step 914 the MME 900 searches for and deletes call-related information stored in association with address information of the S-GW 902. In this case, the MME 900 may also transmit a cell delete request message to a specific eNB sequentially with a time interval in the process of deleting the call-related information, so that the eNB can be avoided from an overhead caused by instantaneous call release.

Meanwhile, a P-GW 904 transmits an echo request message to the S-GW 902 in step 920, and waits for an echo response message received from the S-GW 902 for a pre-set time in step 922. If an abnormal situation occurs in the S-GW 902 or on a path to the S-GW 902 and thus the P-GW 904 fails to receive the echo response message within the pre-set time, or if the echo response message is received within the pre-set time but reset count information included in the received echo response message is changed, the P-GW 904 recognizes occurrence of a path failure with respect to the S-GW 902. Accordingly, the P-GW 904 searches for and deletes call-related information stored in association with the address information of the S-GW 902 in step 924.

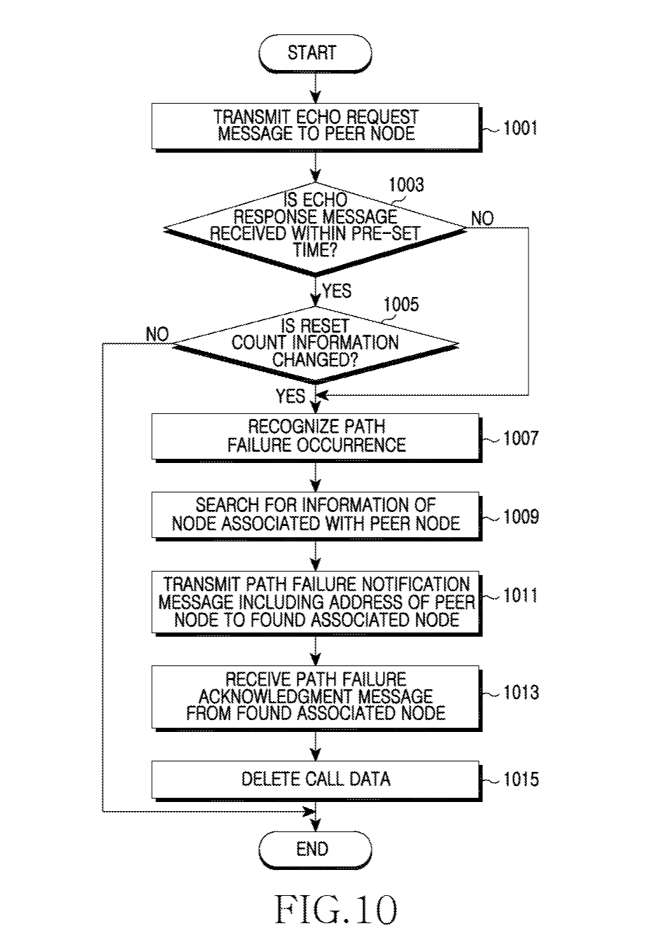

FIG. 10 is a flowchart illustrating a process of performing path management by an S-GW by recognizing occurrence of a path failure with respect to a peer node in an EPC system according to an exemplary embodiment of the present invention.

Referring to FIG. 10, the S-GW transmits an echo request message to the peer node in step 1001, and examines whether an echo response message is received from the peer node within a pre-set time in step 1003. The peer node may be, for example, an eNB, an MME, and/or a P-GW.

If the echo response message is not received within the pre-set time, the procedure proceeds to step 1007. If the echo response message is received within the pre-set time, then in step 1005, the S-GW examines whether reset count information included in the received echo response message is changed.

If the reset count information is not changed, the S-GW recognizes that the peer node operates normally, and then the process of FIG. 10 ends. If the reset count information is changed, proceeding to step 1007, the S-GW recognizes occurrence of a path failure since a system of the peer node is down or an abnormal situation occurs on a path to the peer node. In step 1009, the S-GW searches for information of a node associated with the peer node. In step 1011, the S-GW transmits to the found node a path failure notification message including a type and address information of the peer node as shown in Table 5 above.

In step 1013, the S-GW receives a path failure acknowledgment message from the found node. In step 1015, the S-GW deletes data related to a call associated with the peer node and the found node.

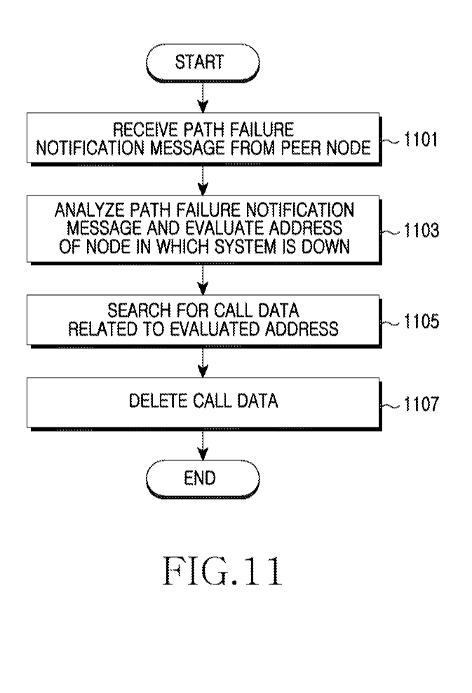

FIG. 11 is a flowchart illustrating a process of performing path management by an MME or a P-GW by receiving information indicating occurrence of a path failure from an S-GW according to an exemplary embodiment of the present invention. Although the following description will be explained with respect to the P-GW, the same also applies to the MME.

Referring to FIG. 11, the P-GW receives a path failure notification message from a peer node (i.e., the S-GW) in step 1101, and analyzes the path failure notification message to evaluate a type and address information of a node in which the path failure occurs in step 1103. In step 1105, the P-GW searches for call-related data stored in association with a node corresponding to the evaluated node type and address. In step 1107, the P-GW deletes the found call-related data.

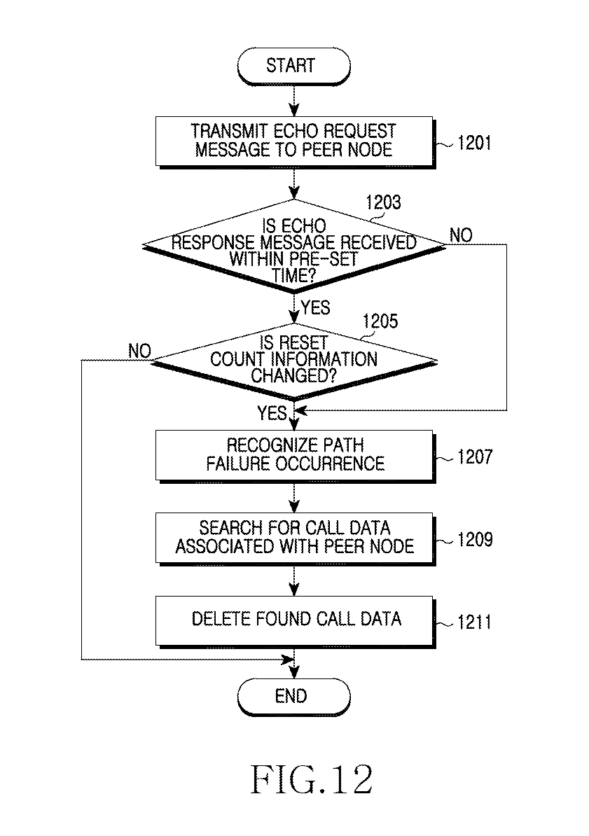

FIG. 12 is a flowchart illustrating a process of performing path management by an MME or a P-GW by recognizing occurrence of a path failure from an S-GW according to an exemplary embodiment of the present invention. Although the following description will be explained with respect to the P-GW, the same also applies to the MME.

Referring to FIG. 12, the P-GW transmits an echo request message to a peer node (i.e., the S-GW) in step 1201, and thereafter examines whether an echo response message is received from the S-GW within a pre-set time in step 1203. If the echo response message is not received within the pre-set time, the procedure proceeds to step 1207. If the echo response message is received within the pre-set time, proceeding to step 1205, the S-GW examines whether reset count information included in the received echo response message is changed.

If the reset count information is not changed, the S-GW recognizes that the peer node operates normally, and then the process of FIG. 12 ends. If the reset count information is changed, then in step 1207, the S-GW recognizes occurrence of a path failure since a system of the peer node is down or an abnormal situation occurs on a path to the peer node. In step 1209, the P-GW searches for call-related data stored in association with the S-GW. In step 1211, the P-GW deletes the found call-related data.

In the aforementioned description, when call-related information is deleted in each node, call release information and accounting information should be managed normally.

According to exemplary embodiments of the present invention, path management is performed between nodes in an Evolved Packet Core (EPC) system by using a create session message and a modify bearer message including a node address and a message for announcing an abnormal status of a specific node. Therefore, unnecessary call-release message creation and transmission are avoided, and thus generation of an overload of an intermediary node and a peer node can be prevented and waste of resources can be prevented. In addition, exemplary embodiments of the present invention can simplify a procedure of handling a path failure and thus there is an advantage in terms of system reliability and resource saving.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of a first node for managing a path between nodes in a mobile communication system, the method comprising:
transmitting a call setup message comprising information about a higher node for a call to a different node and/or receiving the call setup message from the different node;
storing the information about the higher node for the call and information about the different node by associating the two pieces of information with the call;
sensing an abnormal operation of a path to a specific node;
searching for a call stored in association with the specific node whose abnormal operation is sensed; and
deleting information related to the call.

2. The method of claim 1, wherein the sensing of the abnormal operation of the path to the specific node comprises:
transmitting a path management message comprising a system reset count of the node to the specific node; and
sensing an abnormal operation of the path to the specific node if a path management response message is not received within a threshold time or if the management response message is received but the node's system reset count included in the management response message is changed.

3. The method of claim 1, wherein the sensing of the abnormal operation of the path to the specific node comprises receiving a message announcing the sensing of the abnormal operation of the specific node from the different node.

4. The method of claim 3, wherein the message announcing the sensing of the abnormal operation of the specific node comprises at least one of a system reset count of the specific node, a type of the specific node, and an address of the specific node.

5. The method of claim 1, further comprising:
transmitting a message announcing the sensing of the abnormal operation of the specific node to at least one node stored in association with the specific node.

6. The method of claim 5, wherein the message announcing the sensing of the abnormal operation of the specific node comprises at least one of a system reset count of the specific node, a type of the specific node, and an address of the specific node.

7. The method of claim 5, further comprising:
receiving a response message for the message announcing the sensing of the abnormal operation of the specific node; and
deleting information related to the call after the response message is received.

8. The method of claim 1, wherein the information about the higher node for the call comprises address information of the higher node.

9. The method of claim 1, wherein the call setup message comprises one of a session setup message and a session update message.

10. An apparatus of an intermediary node for managing a path between nodes in a mobile communication system, the apparatus comprising:
a transceiver for transmitting a call setup message comprising information about a higher node for a call to a different node and/or for receiving the call setup message from the different node;
a storage module for storing the information about the higher node for the call and information about the different node by associating the two pieces of information with the call;
a sensor for sensing an abnormal operation of a path to a specific node; and
a call session manager for searching for a call stored in association with the specific node whose abnormal operation is sensed, and for deleting information related to the call.

11. The apparatus of claim 10, wherein the transceiver transmits a path management message comprising a system reset count of the node to the specific node, and senses an abnormal operation of the path to the specific node if a path management response message is not received within a threshold time or if the management response message is received but the node's system reset count included in the management response message is changed.

12. The apparatus of claim 10, wherein the transceiver receives a message announcing the sensing of the abnormal operation of the specific node from the different node.

13. The apparatus of claim 12, wherein the message announcing the sensing of the abnormal operation of the specific node comprises at least one of a system reset count of the specific node, a type of the specific node, and an address of the specific node.

14. The apparatus of claim 10, wherein the transceiver transmits a message announcing the sensing of the abnormal operation of the specific node to at least one node stored in association with the specific node.

15. The apparatus of claim 14, wherein the message announcing the sensing of the abnormal operation of the specific node comprises at least one of a system reset count of the specific node, a type of the specific node, and an address of the specific node.

16. The apparatus of claim 14, wherein,
the transceiver receives a response message for the message announcing the sensing of the abnormal operation of the specific node; and
the call session manager deletes information related to the call after the response message is received.

17. The apparatus of claim 10, wherein the information of the higher node for the call comprises address information about the higher node.

18. The apparatus of claim 10, wherein the call setup message comprises one of a session setup message and a session update message.

19. A method of managing a path failure in a network, the method comprising:
transmitting an echo request including a system reset count to a first node;
determining that a path failure has occurred with respect to the first node when no response to the echo request is received from the first node within a predetermined time, or when a system reset count in the response has changed;
when a path failure is determined to have occurred with respect to the first node, searching for call data associated with the first node and deleting the call data associated with the first node; and
obtaining information about at least one second node associated with the first node, and transmitting a path failure notification message to the at least one second node, the path failure notification message indicating that a path failure has occurred with respect to the first node.

20. The method of claim 19, further comprising:
receiving a path failure acknowledgement message from the at least one second node in response to the transmission of the path failure notification message,
wherein the call data associated with the first node is deleted upon receipt of the path failure acknowledgement message, and
wherein the path failure notification message includes a node type of the first node and address information of the first node.

21. A method of managing a path failure in a network, the method comprising:
receiving a path failure notification message from a first node, the path failure notification message including a node type of a second node and address information of the second node;
transmitting a path failure acknowledgement message to the first node upon receipt of the path failure notification message; and
searching for and deleting call information related to the second node based on the node type and address information.

22. An apparatus for managing a path failure in a network, the apparatus comprising:
a call distribution and resource management module for transmitting an echo request to a first node via a communication unit and for receiving an echo response from the first node, and for determining whether a path failure has occurred with respect to the first node when no echo response is received from the first node within a predetermined time or a system reset count included in the echo response has changed;
a call session management module for searching for and deleting call information related to the first node when the call distribution and resource management module determines that the path failure has occurred, obtaining call information about at least one second node related to the first node, transmitting a path failure notification to the at least one second node; and
a call-related information storage module to store the call information related to the first node.

23. The apparatus of claim 21, wherein, receives a path failure acknowledgement message from the at least one second node, and deletes the call information upon receipt of the path failure acknowledgment message from the at least one second node.

24. An apparatus for managing a path failure in a network, the apparatus comprising:
a call-related information storage module for storing call information related to a first node; and
a call session management module for receiving a path failure notification message from a second node, the path failure notification message indicating that a path failure has occurred with respect to the first node, for transmitting a path failure acknowledgment message to the second node, and for deleting the call information related to the first node in response to receiving the path failure notification message,
wherein the path failure notification message includes a node type of the first node and address information of the first node.
